(19) United States
(12) Patent Application Publication
(10) Pub. No.: US 2003/0061323 A1
(43) Pub. Date: Mar. 27, 2003

(54) Hierarchical system and method for centralized management of thin clients

(76) Inventors: Kenneth H. East, Austin, TX (US); Tonja S. Miller, Austin, TX (US); Mark C. Dennison, Austin, TX (US); Thomas C. Lea V, Austin, TX (US); James A. O'Neill JR., Austin, TX (US)

Correspondence Address: Dan R. Christen, Conley, Rose, & Tayon, P.C., P.O. Box 398, Austin, TX, 78767, US

(21) Appl. No.: 09/781,075

(22) Filed: Feb. 8, 2001

Related U.S. Application Data
(60) Provisional application No. 60/211,748, filed on Jun. 13, 2000.

(51) Int. Cl. G06F 15/173

(52) U.S. Cl. 709/223; 709/242

(57) ABSTRACT

A system and method for managing a network of thin clients is disclosed. The thin clients may be organized into a hierarchy with multiple administrative servers in a hierarchy, each managing one or more thin clients. Updates to thin client configurations may be performed by propagating update information to a top-level master administrative server, which in turn conveys the update information to one or more lower-level remote administrative servers, which in turn convey the update information to their managed thin clients. To simplify network management, the thin clients may be organized into arbitrary clusters, regardless of their position within the hierarchy structure. The hierarchy may also be used to control the propagation of error messages from thin clients. The hierarchy may be implemented using a thin client management program that configures thin clients according to their position within the hierarchy.

### CROSS-REFERENCE TO RELATED APPLICATIONS

This application claims the benefit of U.S. Provisional Application No. 60/211,748, filed Jun. 13, 2000.

### BACKGROUND OF THE INVENTION

1. Field of the Invention

The present invention generally relates to distributed thin-client networks. More particularly, the present invention relates to hierarchical techniques for management and configuration of distributed thin-client networks.

2. Description of the Related Art

Many industries rely on thin-client networks to conduct business and manage their information. In client/server applications, a client computer is typically designed to be small (i.e., with limited processing resources) so that the bulk of the data processing occurs on the application server. Although the term thin client usually refers to software, it is increasingly used for computers that are designed to serve as the clients for client/server architectures. A thin client is typically thought of as a computer without local storage and with a lower speed CPU (central processing unit), whereas a fat client includes local storage. A thin client typically includes a hardware platform (e.g., local memory, local processor, keyboard, pointing device, and a display device), a local small footprint operating system (e.g., Windows CE™ from Microsoft Corporation), and one or more client programs that when executed allow the thin client to connect to an application server configured to execute programs on behalf of the thin client. In contrast, a fat client is a computer with a full-featured hardware platform (e.g., including peripherals such as CD-ROM), a large, full-featured operating system, and local applications which are executed on the fat client as opposed to an application server. Some thin clients may be designed to only connect to application servers, whereas other thin clients may be designed to also connect to the Internet.

The idea behind thin clients is that many users that are connected to a network do not need all the computer power they can get from a typical personal computer or workstation. Instead, these users can rely on the power of application servers to process and store data. Thin clients take this idea one step further by also minimizing the amount of memory and processor power required by the client. One of the strongest arguments behind thin clients is that they reduce the total cost of ownership—not only because the machines themselves are less expensive than PCs, but also because the applications that are accessed by thin clients can be administered and updated from an administrative server. As used herein, the term “application server” refers to a computer that executes applications for one or more thin clients, whereas the term “administrative server” refers to a computer that remotely administers thin clients. In some cases, an application server for a thin client may also act as an administrative server for the thin client. In other configurations, separate computers may act as application and administrative servers.

In some cases, however, the task of administering and updating thin clients can become daunting, particularly when the network includes different computers with different hardware and software configurations (typically referred to as a heterogeneous network). While most network management applications can handle simple tasks such as distributing a software update to every computer on a homogenous network, many management packages make it difficult for network administrators to select particular subsets of thin clients for particular updates. Recent increases in the size of networks, both in geographical terms and number of thin clients, has exacerbated this problem. For example, given a network having more than 1000 thin clients across the United States and Europe, it is time consuming for network administrators to selectively update software based on a number of different criteria. For example, the network administrator may need to update all thin clients used by managers to have a certain configuration that enables the thin client to interface/execute a particular management application on an application server. However, different versions of the configuration may be needed based on the thin client's geographic location (e.g., to support different network protocols due to differences in the thin clients' network connections due to variances in local telephone networks). Given a network with hundreds of thin clients used by managers in different locations, performing selective updates can be time consuming. Thus, a system and method for managing thin-client networks is desired.

### SUMMARY OF THE INVENTION

The problems described above may at least in part be solved by a system and method for managing networks of thin clients using a hierarchy capable of supporting multiple masters. The network includes a number of computers, including one or more application servers, one or more administrative servers, and one or more thin clients. As noted above, in some cases a particular computer acting as an application server may also act as an administrative server. The application servers execute applications for the thin clients, while the thin clients display results to end users and convey the end users' inputs to the application server. One or more of the administrative servers are configured as master administrative servers. Master administrative servers issue commands to one or more administrative servers called remote administrative servers. In some configurations, an administrative server may be both a master and a remote (e.g., if the server is in the middle of the control hierarchy). Each master administrative server controls configuration changes for its remote administrative servers and any thin clients that are configured to be controlled directly by the master administrative server. Thus, a control hierarchy for updating thin clients may be constructed by designating particular administrative servers as masters and/or remotes, and by configuring each thin client to receive configuration updates from a particular administrative server. Configuration updates are initiated (e.g., by a network administrator) using the master administrative server that is at the top of the control hierarchy. The configuration update is then propagated down the hierarchy from the master administrative server to the master's remote administrative server. Each of the remote administrative servers then propagate the update to their remote servers (if any) and their thin clients. This process continues until all thin clients on the network have been updated. Advantageously, in some networks this hierarchical structure may significantly reduce the time needed to perform updates because at least some of the updates may be conveyed in parallel. Another potential benefit, depending upon the exact implementation, is that an update may be deployed from one master administrative server to multiple remote administrative servers over a low bandwidth WAN connection, and then those remote administrative servers may in turn deploy the update over LANs, which typically have much more bandwidth available. By reducing the number of transmissions over the WAN, the update is processed faster and less bandwidth outside of the organization's LANs is used, thus potentially reducing expenses. The hierarchical structure may also be used to control the propagation of status and error messages from clients to the master administrative server at the top of the control hierarchy.

Thus, network-wide updates for all thin clients may be performed by downloading update information from each master administrative server to the master's remote administrative servers and the master's thin clients, and then from the remote servers to the remote server's thin clients. In some embodiments, distributing updates may be further automated by grouping or clustering thin clients together. For example, the thin clients may be organized into arbitrary groups or clusters. A cluster is a logical group of thin clients and/or remote administrative servers and other clusters. A cluster may be a group of thin clients that share a geographical location or common hardware type. In one embodiment, thin clients may be clusters only under the administrative server that manages them. These clusters may be individually selected or deselected for updates to provide network administrators with increased flexibility in performing network management tasks.

In one embodiment, the system and method described above may be implemented as a thin client management program. The program may be configured to execute on one of the administrative servers in the network, and the program may allow network administrators the flexibility to remotely take control of any administrative server in the network from the administrative server executing the thin client management program. The program may also be configured to implement a graphical user interface to further assist network administrators. In one embodiment, the graphical user interface may support “drag-and-drop” functionality to allow network administrators to copy configurations from one thin client to another or move thin clients or administrative servers between clusters.

In one embodiment, a method for managing a network of thin clients and servers may include displaying a hierarchical network diagram of the network and prompting a user (e.g., a network administrator) to configure a particular thin client on the network. Once the configuration has been completed, the user may select one or more additional thin clients, and the configuration may be copied to the one or more additional thin clients by the user by dragging and dropping an icon representing the first thin client onto an icon representing one of the additional thin clients. Alternatively, the user may select the one or more additional thin clients by shift-clicking icons representing the one or more additional thin clients. According to another method, the user may select one or more additional thin clients by clicking one or more master administrative servers in the network diagram, wherein clicking a particular master administrative server selects all thin clients controlled directly by that master or indirectly by that master via its remote administrative servers.

### BRIEF DESCRIPTION OF THE DRAWINGS

A better understanding of the present invention may be obtained when the following detailed description of the preferred embodiment is considered in conjunction with the following drawings, in which:

FIG. 1 is a network diagram of one embodiment of a wide area network;

FIG. 2 is an illustration of one embodiment of a typical computer system;

FIG. 3 is an illustration of one embodiment of a typical thin client;

FIG. 4 is an illustration of one embodiment of a one embodiment of a network hierarchy;

FIG. 5 is an illustration of one embodiment of a graphical user interface for managing clusters of thin clients;

FIG. 6 is an illustration of one embodiment of a method for adding new clusters of thin clients to a network hierarchy;

FIG. 7 is an illustration of one embodiment of a method for adding new sub-clusters of thin clients to a network hierarchy;

FIG. 8 is an illustration of one embodiment of a method that supports drag-and-drop functionality for managing a network of thin clients;

FIGS. 9A-C illustrate one embodiment of a method for adding a master administrative server named Seattle to an example hierarchy;

FIGS. 10A-E illustrate one embodiment of a thin client management program configured to allow automatic configuration of new thin clients;

FIGS. 11A-B illustrate one embodiment of a thin client management program configured to allow manual configuration of new thin clients;

FIGS. 12A-C illustrate one embodiment of a thin client management program configured to allow configurations to be copied from one thin client to another including multiple targets;

FIGS. 13A-C illustrate one embodiment of a thin client management program that is configured to allow update tasks to be scheduled;

FIG. 14 is a data flow diagram illustrating one embodiment of the transfer of instructions between a management system portion of the thin client management program and the agent portion of the thin client management program that utilizes Simple Network Management Protocol (SNMP);

FIG. 15 is a diagram illustrating the transfer of trap information from the agent portion of the thin client management program of FIG. 14 to the management system portion of the thin client management program that utilizes SNMP;

FIG. 16 is a diagram of one embodiment of a network management application that utilizes SNMP; and

FIG. 17 is an event trace diagram for one embodiment of a method for retrieving thin client information.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. Please also note that the headings used herein are for organizational purposes only and are not meant to have any effect on the interpretation of the claims or the detailed description.

### DETAILED DESCRIPTION OF SEVERAL EMBODIMENTS

Before describing the system and method in greater detail, some examples of networks and thin clients are discussed.

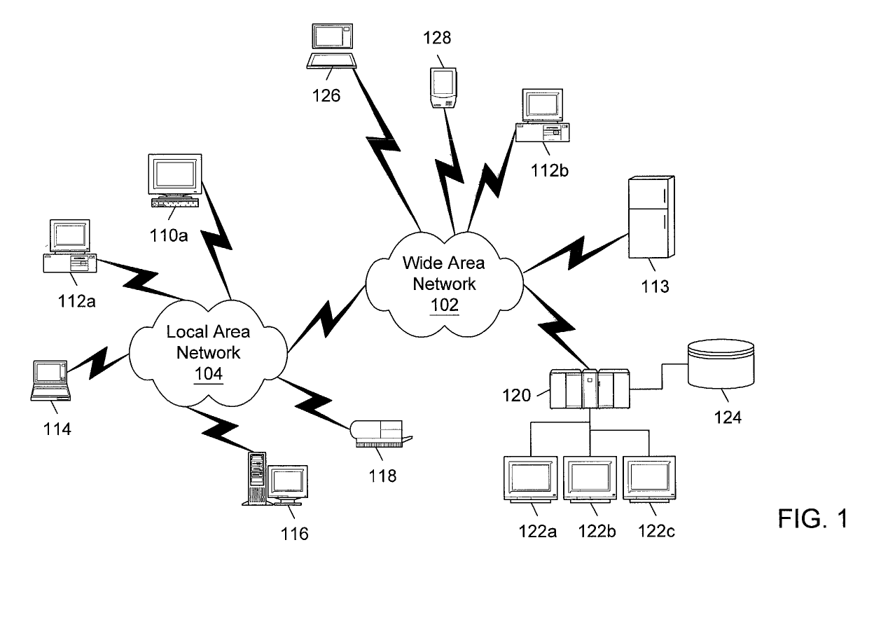

FIG. 1: Wide area network

FIG. 1 illustrates one embodiment of a wide area network (WAN) 102 that may be used to implement the system and method for thin client management disclosed herein. WAN 102 is a network that spans a relatively large geographical area. The Internet is one example of a WAN, although other WANs (e.g., private WANs) and/or LANs may also be used. In some embodiments firewalls may be used to open the ports that the thin client management program (described in greater detail below) uses to communicate. As used herein, the “Internet” is a decentralized global network connecting a large number of computers through standard communication and data protocols. WAN 102 typically includes a number of computer systems which are interconnected through one or more networks. Although one particular configuration is shown in FIG. 1, the WAN 102 may include a variety of heterogeneous computer systems and networks which are interconnected in a variety of ways and which run a variety of software applications.

One or more application servers 120 may also be coupled to WAN 102. As shown, server 120 may be coupled to a storage device 124 and thin clients 122a, 122b , and 122c. The thin clients 122a, 122b, and 122c may access data stored in the storage device or file server 124 coupled to or included as part of the application server 120. WAN 102 may also include computer systems 112b, personal digital assistants (PDAs) 128, and Internet appliances 126 and 113 (e.g., a refrigerator configured to order groceries using the Internet) which are connected to WAN 102 individually. Some of devices 112b, 128, 126, and 113 may also function as thin clients.

One or more local area networks (LANs) 104 may be coupled to WAN 102. LAN 104 is a network that spans a relatively small area. Typically, a LAN 104 is confined to a single room, floor, building or group of buildings. Each node (i.e., individual computer system or device) on LAN 104 may have its own CPU with which it may execute programs or act as thin client (i.e., displaying information and relaying user input). Depending upon the exact configuration, each node may be able to communicate and share information with other devices on LAN 104 (e.g., via an application server). Thus LAN 104 may allow many users to share devices (e.g., printers) as well as data and applications stored on application servers connected to LAN 104. LAN 104 may be characterized by any of a variety of types of topology (i.e., the geometric arrangement of devices on the network) and/or protocols (i.e., the rules and encoding specifications for sending data, and whether the network uses a peer-to-peer or client/server architecture), and may use a variety of different transmission media (e.g., twisted-pair wire, coaxial cables, fiber optic cables, microwaves, radio waves, or infrared light communication links).

LAN 104 may include a number of interconnected computer systems and optionally one or more other devices: for example, one or more workstations 110a, one or more personal computers 112a, one or more laptop or notebook computer systems 114, one or more server computer systems 116, and one or more network printers 118. As illustrated in FIG. 1, LAN 104 may include one of each of computer systems 110a, 112a, 114, and 116, and one printer 118. LAN 104 may be coupled to other computer systems and/or other devices and/or other LANs 104 through the WAN 102.

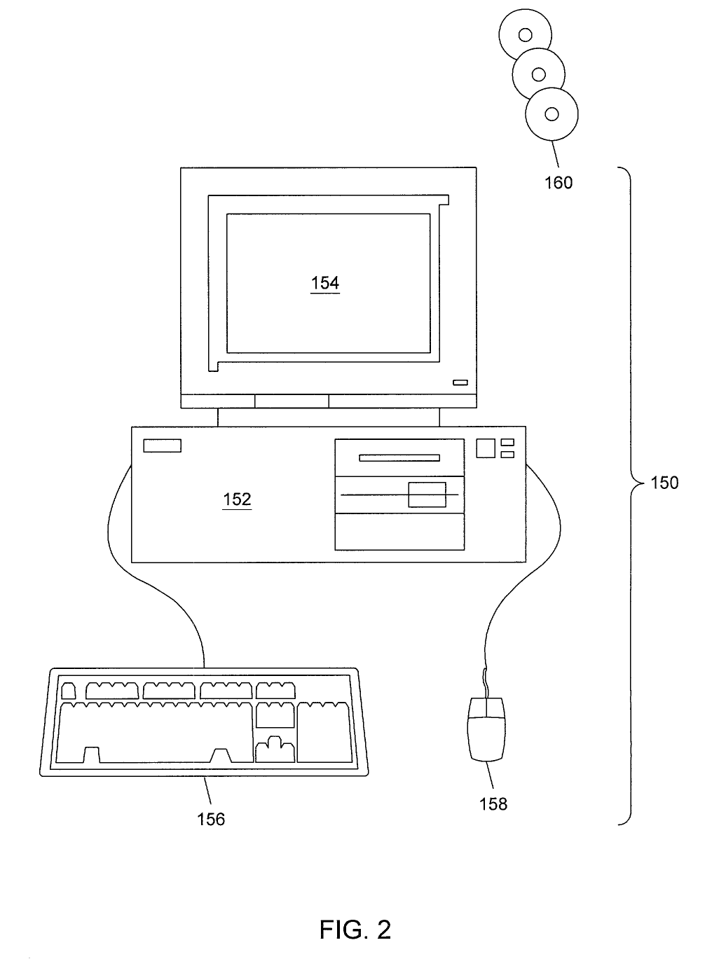

FIG. 2: Example Computer System

FIG. 2 illustrates a typical computer system 150 which is suitable for implementing various embodiments of the system and method for managing a network of thin clients. For example, computer system 150 may be configured as an application server and/or an administrative server, as described in greater detail below. Computer system 150 typically includes components such as a CPU 152 with an associated memory medium 160. The memory medium may store program instructions for computer programs, wherein the program instructions are executable by the CPU 152 (or more specifically, by the one or more processors within CPU 152 ). The system may also have one or more hard drives (e.g., a RAID array). The computer system 150 may further include a display device such as a monitor 154 (e.g., a liquid crystal display or “LCD”, a cathode ray tube display or “CRT”, a head mounted display, or a projection display), an alphanumeric input device such as a keyboard 156, and a directional input device such as a mouse 158 or a trackpad.

The computer system 150 preferably includes memory medium 160 on which computer programs according to various embodiments may be stored. The term “memory medium” is intended to include an installation medium, e.g., a CD-ROM, DVD-ROM, or floppy disks, a computer system memory such as DRAM, SRAM, EDO RAM, Rambus RAM, and a non-volatile memory such as a magnetic media, e.g., a hard drive, or optical storage. Memory medium 160 may include other types of memory as well, or combinations thereof.

Memory medium 160 preferably stores one or more applications for execution by the computer system for a thin client. Memory medium 160 may also store an embodiment of a thin client management program as described in greater detail below. The software program(s) may be implemented in any of various ways, including procedure-based techniques, component-based techniques, and/or object-oriented techniques, among others. For example, the software program may be implemented using ActiveX controls, C routines, C++ objects, JavaBeans, Microsoft Foundation Classes (MFC), Java, traditional programs, or other technologies or methodologies, as desired.

While computer system 150 may run a number of different operating systems depending on the exact implementation, Windows NT™ 4.0 and higher from Microsoft Corporation (e.g., Windows NT Workstation™, Windows NT Server™, Windows NT Terminal Server™) is preferred in some embodiments.

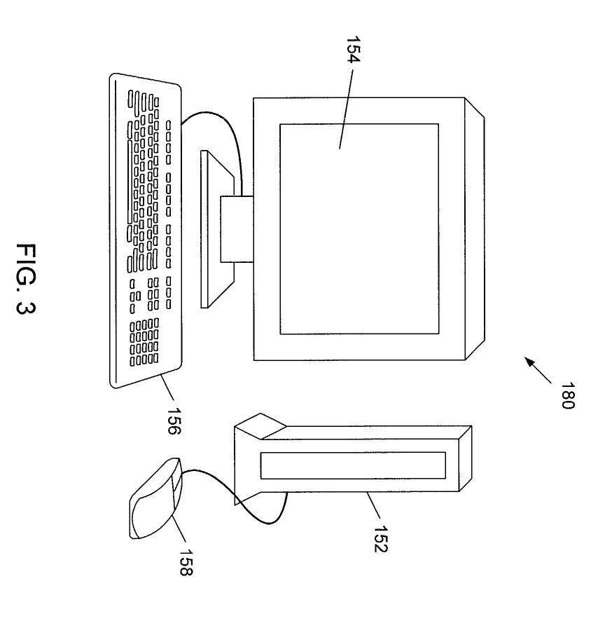

FIG. 3: Example Thin Client

FIG. 3 illustrates one embodiment of a thin client 180 that may be used as part of a network of thin clients as described in greater detail below. While different thin clients may be used, thin clients from Boundless Technologies, Inc. (e.g, a Capio™, Capio II™, or Viewpoint™ series of thin clients) are preferred. Thin client 180 may be configured to communicate with one or more application servers and one or more administrative servers, as described in greater detail below. Thin client 180 may comprise display device 154 (e.g., a 14″ LCD flat panel display), CPU 152, and keyboard 156. In some embodiments, keyboard 156 may be wireless (e.g., infrared). CPU 152 may include RAM (random access memory) and flash memory (i.e., non-volatile memory) for storing programs and data. CPU 152 may also include support for a pointing device such as mouse 158, or a track ball or joystick. In other embodiments, CPU 152 may support versions of display device 154 that are touch screens. Thin client 180 may also comprise speakers a microphone, and a digital camera (not shown). While each configuration may vary, in one embodiment CPU 152 may include additional ports (e.g., serial RS-232 ports), USB (Universal Serial Bus) ports, a microphone input, and an amplified headphone output port. CPU 152 may also be configured with an external volume control, external contrast control, an AC power adapter, dual RJ-11 phone jacks for line-in and telephone-out, and both flash memory and SDRAM (synchronous dynamic random access memory).

Thin client 180 may be configured with software that allows the client to emulate a number of different terminals (e.g., Wyse 50, VT-52, VT-100, ANSI, SCO Console). Thin client 180 may be connected to a LAN or WAN using a number of different connections (e.g., a telephone or cable modem, or a 10/100BaseT Ethernet card connection). Thin client 180 may use the LAN or WAN connection to communicate with application servers and administrative servers. Thin client 180 may be configured to run one or more different operating systems (e.g., Windows CE™ or Linux™), and may be configured to run remote thin client software (e.g., Citrix ICA™ from Citrix Corporation).

Other optional hardware may be included with thin client 180, depending upon the tasks to be performed by the client. For example, a bar code scanner, a smart card reader, a Java™ ring interface, a digital camera, a retinal scanner, a thumb print scanner, a microphone, or a voice synthesizer (for text-to-speech) may also be included with thin client 180.

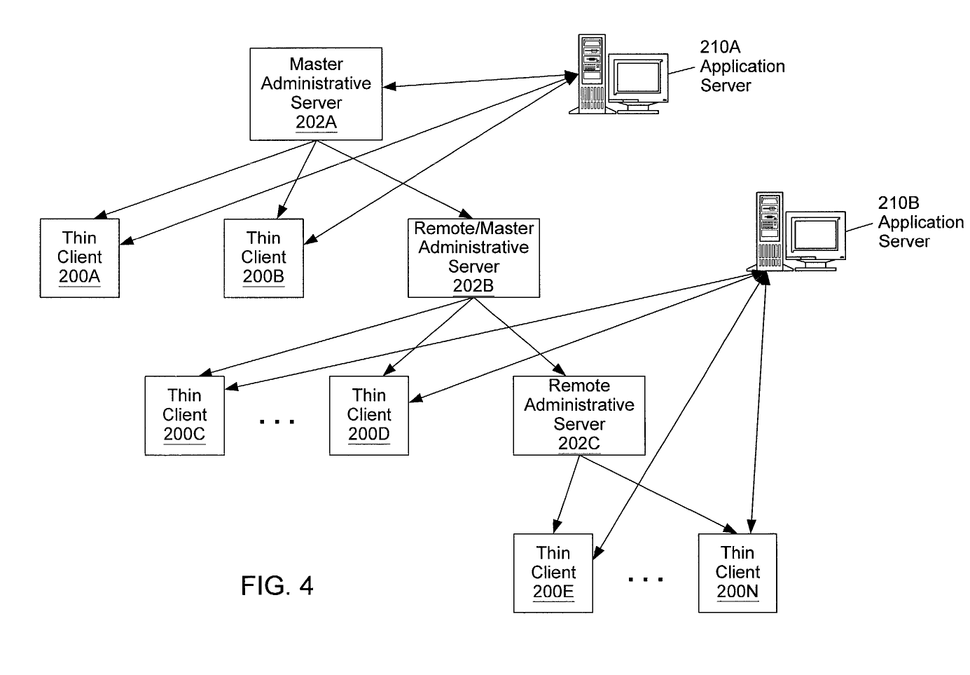

FIG. 4: Hierarchical Management

Turning now to FIG. 4, one embodiment of a network hierarchy is shown. In this embodiment, the network hierarchy comprises a number of thin client computers 200A-N, one or more administration servers 202A-C, and one or more application servers 210A-B. Thin client computers 200A-N may be configured such as the one described in connection with FIG. 3, but in some networks other types of computers may also be used, such as personal computers, notebook computers, set-top boxes, personal digital assistants (PDAs), and/or workstations (e.g., running terminal emulation programs). The thin clients may connected as part of a network such as the wide area network shown in FIG. 2, but smaller local area networks (LANs) and other types of networks are also possible. Within the network, the computers may be connected by dial-up connections, fiber optic and/or T1 connections, ISDN (integrated services digital network) connections, Ethernet connections, DSL (digital subscriber line) connections, cable connections, satellite connections, or other wireless connections.

Note, however, that the connections shown in the figure (e.g., between master administrative server 202A and thin clients 200A-200B) do not necessarily represent physical network connections, but rather indicate a control hierarchy. For example, in one embodiment all computers (including clients 200A-N and 202A-C and servers 210A-B) are connected to the Internet through a dial-up connection (e.g., through a local ISP—Internet Service Provider). The control hierarchy is described in greater detail below.

Within the network, one or more computers may be configured as master administrative servers (see computers 202A-B) and/or remote administrative servers (see computers 202B-C). One or more computers may also be configured as application servers (see computers 210A-B). As noted above, in some embodiments of the network, a single computer may act as both an administrative server and an application server. For example, remote administrative server 202C and application server 210B may be a single computer. Similarly, master administrative server 202A and application server 210A may be a single computer. In some embodiments, each remote administrative server in the network may be restricted to having only one master administrative server. In other embodiments, multiple master administrative servers may manage a particular remote administrative server. Similarly, in some embodiments thin clients may be restricted to having only one administrative server. In other embodiments multiple administrative servers may be allowed for a particular thin client.

As noted earlier, an administrative server is a computer that controls updates and configurations for one or more other administrative servers and/or one or more thin clients. In contrast, a thin client does not control updates for any other computers. As shown in the figure, there may be multiple levels of master administrative servers within a particular network. For example, remote/master administrative server 202B controls updates for thin clients 200C-D and remote administrative server 202C, but master 202B is controlled by master 202A. While masters may be client computers, an application server such as server 210A may also be configured to operate as a master or remote and control updates for one or more clients. As used herein, an update refers to the process of providing new configuration and/or customization information for one or more thin clients on the network. For example, an operating system update, the addition of a new device driver, a change in device settings (e.g., screen resolution, color depth), or the addition of a new application (e.g., a plug-in type application for a browser) are all examples of updates that may all be accomplished by master administrative server 202A conveying update information to remote/master administrative server 202B and thin clients 200A-B. Remote/master administrative server 202B then conveys the update to remote server 202C and thin clients 200C-D. Remote server 202C then conveys the update to thin clients 202E-N.

The traditional approach to administering updates has been to have one master administrative server that conveys updates to all of the thin clients on the network. As noted above, however, many of the thin clients on the network may have limited bandwidth connections (e.g., 28.8 k dial-up connections). As a result, it may take the single master a substantial period of time to complete updating all thin clients in a serial fashion. This may be particularly problematic if there are several thousand thin clients on the network with low bandwidth connections. In contrast, by designating multiple administrative servers and using a hierarchy as shown in FIG. 4, the task of updating thin clients may be distributed. This may advantageously allow the updating to be performed in parallel. For example, once the update information has been conveyed to remote/master administrative server 202B from master administrative server 202A, server 202B may update thin clients 200C-D in parallel with master 202A updating thin clients 200A-B.

In the preferred embodiment, a thin client management program is executed on one or more of the administrative servers by a network administrator to configure and manage the network hierarchy shown in FIG. 4. Initially, the network may be configured a single master and a number of thin clients. The program may prompt the network administrator to specify which servers shall be application servers and/or administrative servers. The program may also prompt the administrator to specify (a) which administrative servers shall be masters over other administrative servers, (b) which thin clients shall be controlled by each administrative server and (b) which thin clients shall be serviced by each application server. Preferably, this is accomplished through the use of a graphical user interface in the management program.

Once the network administrator has selected a particular computer to be a master administrative server, the management program may prompt the network administrator to enter additional information that is usable to configure the network hierarchy. The remote administrative servers may be configured with the network address of the master that will control them. The program may also cause the master to download an update to the newly designated remote administrative servers and thin clients. This update may include the network address of the new master. Thus, after the initial update, the thin clients and remote administrative servers will access the new master for updates instead of any previously designated master.

Once the network is configured in a hierarchical manner as shown in FIG. 4, the network administrator may proceed with regular updates. For example, the network administrator may configure the computers' hardware to desired settings, such as specific screen resolutions, color depths, adding specific software (e.g., ICA, RDP, terminal emulation clients), changing TCP/IP configurations, adding or modifying mouse support (left handed/right handed), and adding or deleting touch screen support.

While some clients on the network may also receive software application updates, in many configurations the thin clients may have no applications loaded locally. Instead, the thin clients may utilize remote connection protocols to operate as terminals executing applications on one or more application servers (e.g., see servers 210A-B in FIG. 4). Examples of such remote connection protocols include ICA (Independent Computing Architecture from Citrix) RDP (Remote Desktop Protocol from Microsoft), and TEC (Terminal Emulation Client). ICA and RDP are configured for connecting to servers executing Microsoft Windows applications, while TEC is configured to connect to applications running on legacy environments (e.g., IBM 5250, 3270, and Unix systems via VT100 terminal emulation). Each of these protocols has one or more client-resident mini-applications that allow the client to interface with applications executing on servers 210A-B. Changes to these client-resident mini-applications may also be accomplished through the update mechanism described above.

Copy Configuration

In one embodiment, the management program be configured to allow network administrators to perform copy configuration operations. The management program may allow the network administrator to configure one thin client with a default configuration and then copy this configuration to other thin clients on the network. In one embodiment the copying is performed using a graphical user interface in which the network administrator right clicks an icon representing a particular thin client to designate it as the default configuration. The administrator may then select which other thin clients will receive the default configuration. In another embodiment, the network administrator may define a default configuration, and then shift-click to copy the default configuration to a set of selected target thin clients. As used herein, the term ”shift-click” refers to the act of clicking a mouse button while a “shift” key on a keyboard is depressed. In yet another embodiment, the network administrator may select the copy configuration operation, and in response the program may display a graphical representation of the network. The network administrator may then simply select (e.g., check off) which clients the default configuration should be transferred to. For example, assuming the network of FIG. 4 is displayed, the network administrator may select thin client 200A as the default configuration, and thin clients 200C-D as targets to which the default configuration should be copied. Depending on the exact embodiment, the configuration may proceed as an update (i.e., with the update propagating through the network hierarchy from master administrative server to remote administrative server to thin client). As noted above, each administrative server may be configured to pass on the update information to each remote administrative server and thin client below in the hierarchy. The network administrator may also be allowed to select a master administrative server, and the program may be configured to automatically copy the default configuration to all clients controlled by that master.

As part of the update process, the management program may be configured to seek out any thin clients (within the cluster of selected clients) for hardware that matches the update (e.g., by model type or by specific hardware feature). The program may then convey the update as described above (i.e., to multiple administrative servers for parallel distribution). In one embodiment, the program, the administrative servers, and/or the thin clients may perform a check operation to ensure that the hardware of the thin client matches the minimum requirements of the configuration update. For example, if the default configuration is a display resolution of 1028×768, a client with a graphics card that only supports a 800×600 display resolution normally would not be able to operate under the default configuration. For cases in which a selected client does not meet the minimum hardware requirements of the default configuration, the program may automatically deselect the client. The program may also notify the network administrator of this deselection. Alternatively, this checking function may be performed by each administrative server before conveying the update to a particular thin client. Yet another alternative is to have each thin client perform the check before incorporating the update. If the hardware does not match the new configuration, the client or the master may provide a fault message back up through the network hierarchy to the network administrator.

In some embodiments, the update process may be configured to run automatically (e.g., once per week). In these configurations, the network administrator need only update one client (i.e., the client designated as having the default configuration) and then monitor the system for fault messages.

In one embodiment, the management program may be implemented such that any new clients added to the network may be automatically configured with a predetermined default configuration. For example, as noted above the configuration associated with a particular thin client may be selected as the default configuration. When any administrative server in the network detects a new thin client accessing the network for the first time, the administrative server may be configured to update the new thin client with the default configuration. Advantageously, this embodiment may allow plug-and-play customization for new clients. New clients shipping from a manufacturer or distributor need only be programmed with the location of an administrative server in the network (or the device may be configured to determine this independently using Dynamic Host Control Protocol—DHCP). Upon initial power up, the new client may be configured to automatically contact the designated administrative server, which then contacts the corresponding master administrative server and downloads the appropriate customization information based on the default configuration.

Task Scheduling

As noted above, in some embodiments the management program may be configured to allow the network administrator to schedule tasks. Schedulable tasks may include updates to the user interface, firmware changes, bug fixes, feature enhancements, network hierarchy reconfigurations, and changes in server addresses. Advantageously, automating these tasks allows them to be performed at times that the thin clients are unlikely to be busy (e.g., after business hours). Once a master receives a task (e.g., an update that is to be conveyed), the master may be configured to perform the task immediately or wait until the target thin client is idle.

Configuration Propagation

In some embodiments, a limit may be placed on the number of thin clients or remote administrative servers that a particular master administrative server may directly control. For example, a master administrative server may be limited to directly controlling no more than 100 computers (i.e., thin clients and remote administrative servers combined). This limit may advantageously improve the speed with which updates are performed and may increase the parallel execution of updates and reducing bandwidth requirements. As noted above, the traditional method for a network with 2,000 clients is to have one master or server send out the update 2,000 times (i.e., updating each client one after another). By limiting the number of clients per administrative server, much of this task may be performed in parallel (e.g., with 20 masters each sending out updates to 100 clients). Assuming a transmission time of one minute per update, the traditional method would take more than a day to complete (i.e., 2,000 minutes), while a system limited to 100 clients per administrative server could, depending upon the implementation, take less than 2 hours (i.e., <120 minutes) to complete the update. To ensure as much of the updating is performed in parallel as possible, in one embodiment each particular administrative server may be configured to convey the update information to any remote administrative servers that the particular master administrative controls first, before conveying the update information to the thin clients.

Remote control

In some embodiments, the management program may allow network administrators to configure a first administrative server to allow a second administrative server to control all of the first administrative servers' thin clients. For example, master administrative server 202A may be in New York, with administrative server 202B being physically located in Germany. Server 202C in Germany may service clients 200E-N, which may located throughout western Europe. By configuring administrative server 202B to relinquish control of clients 200E-N, a network administrator in New York may have direct control of updates to administrative server 202B's clients without physically having to travel to Europe. Thus, once master 202B has been appropriately configured to pass control to administrative server 202A, the network administrator sitting in New York may perform all update tasks as if the network administrator was sitting in front of administrative server 202B in Germany.

This functionality may be implemented in a number of different ways. For example, in one embodiment the administrative server that is relinquishing control may forward all updates and messages from the server that has seized control to the thin clients and administrative servers below in the hierarchy. In another embodiment, the administrative server that is relinquishing control may instruct all of the computers under its control to temporarily accept instructions from a new administrative server (i.e., the remote controlling master), thereby allowing direct communication between the thin clients and new administrative server. Other control schemes are also possible and contemplated. For example, one administrative server may be a primary server, with the second administrative server configured to monitor the primary server. In the event that the primary server is no longer functioning, the secondary server may take over.

Security

While this level of control is powerful, it may also raise security concerns. To address these concern, the management program may configure administrative servers to one of three different security states. In the first state, the administrative server is configured to act as a master-only. In this state, the administrative server does not accept instructions from, or relinquish control to, other administrative servers. This state may be used for the top master administrative server (e.g., master administrative server 202A in FIG. 4), or for high security installations. To update clients that are serviced by an administrative server that is set to master-only, the network administrator would have to physically access the master-only administrative server. In the example above, the network administrator would have to travel to New York to perform updates to thin clients 200A-B and remote/master administrative server 202B.

In the second state, the master is configured to accept instructions from, and relinquish control to, master administrative servers having specified Internet Protocol (IP) addresses or domain names. In some embodiments, this may be limited to a single IP address/domain name. In other embodiments, multiple IP addresses/domain names may be specified.

In the third state, the administrative server is configured to accept instructions from any other administrative server. This may be useful for installations where security is a lower concern than ease of access.

The state of the administrative server may be changed, but this control may be password protected to prevent unauthorized changes. Furthermore, the administrative server may require a user to have physical access before allowing a state change to be made (e.g., preventing state changes unless the request comes from a local keyboard). Thus, if administrative server 202B is located in Germany, the network administrator would have to travel to Germany to make a state change to administrative server 202B.

To further increase security, each administrative server may be configured with different user groups that have different permissions. For example, one class of users may be “Help Desk Users” that only have rights to view thin client configurations without making changes. In some embodiments, each administrative server in the first or second state may be further configured with additional passwords that are required from the master before control is relinquished. In one embodiment, no remote administrative server or thin client may more than one primary master. The secondary master may not communicate unless the primary master is no longer able to communicate. The thin client may initiate the switch to the secondary master if communication to the primary master is lost.

Terminal Clustering

Many prior solutions only permit grouping according to network structure (e.g., a single server with a large number of managed thin clients). In contrast, the management program as contemplated herein may be configured to allow network administrators to group or cluster thin clients according to arbitrary features. For example, assuming a particular thin client is in Germany, it may nevertheless be configured as part of a group with mostly California-based clients. By not placing limits on which clients may belong to a particular cluster, all clients used by marketing employees may be put in one cluster, while all thin clients used by order-entry personal may be grouped into a different cluster, regardless of geographical location or network address. Thus, even if a network has multiple domains (e.g., different Windows NT domains, LANS, functional departments, different buildings, different cities), clients from different domains may be grouped to form a cluster. This cluster may then be used for management purposes (e.g., firmware updates), and for other system administration functions (e.g., network monitoring, load management, and network messaging).

One example relates to hardware configurations for the thin clients. For example, assuming that only point-of-sale clients have touch screens, creating a cluster for point-of-sale clients (regardless of geographic location) may allow network administrators to quickly update the touch screen device drivers for these clients (e.g., by selecting the point-of-sale cluster and performing an automated update to only these clients). When using clusters for updates, each administrative server may receive an indication as to which thin clients should or should not receive the update. The management program may be configured to create multiple clusters (e.g., with a single client belonging to multiple clusters) to simplify updates. Using the above example, an additional cluster for Spanish-language clients may be created, wherein some of the point-of-sale clients also belong to the Spanish-language cluster. This may allow the network administrator to send user interface updates to different clients in the appropriate language.

Fault Management

The hierarchical structure outlined above may also be used to provide advanced fault handling and management. This may be particularly advantageous in larger networks (e.g., those with thousands of clients). For example, once an automatic update has been performed, a number of clients may generate status or error messages (collectively, “fault messages”). In traditional systems, it may be difficult to manage the hundreds of messages generated by the clients. However, using a graphical user interface and the hierarchical structure outlined above, the management program may create summaries of alarms. These alarm summaries may be prioritized according to a predetermined priority scheme which may be displayed using the graphical user interface. For example, assuming the network structure of FIG. 4, a graphical image representing the network of FIG. 4 may be displayed with each administrative server having a number showing the number of severe error messages for the administrative server and all clients controlled by the administrative server and all clients controlled by administrative servers below in the hierarchy. The user may then select a particular administrative server (e.g., by double clinking on the administrative server's error count number) to display a list of the errors associated with the administrative server. In this manner, the network administrator may be able to view only the highest priority messages at the top of the hierarchy and then “drill-down” to see details as desired. For example, each administrative server may be configured to forward only the highest priority error messages to their master administrative server. In another embodiment, all error messages are forwarded to the topmost master administrative server, and then the management program may provide various display and filtering options.

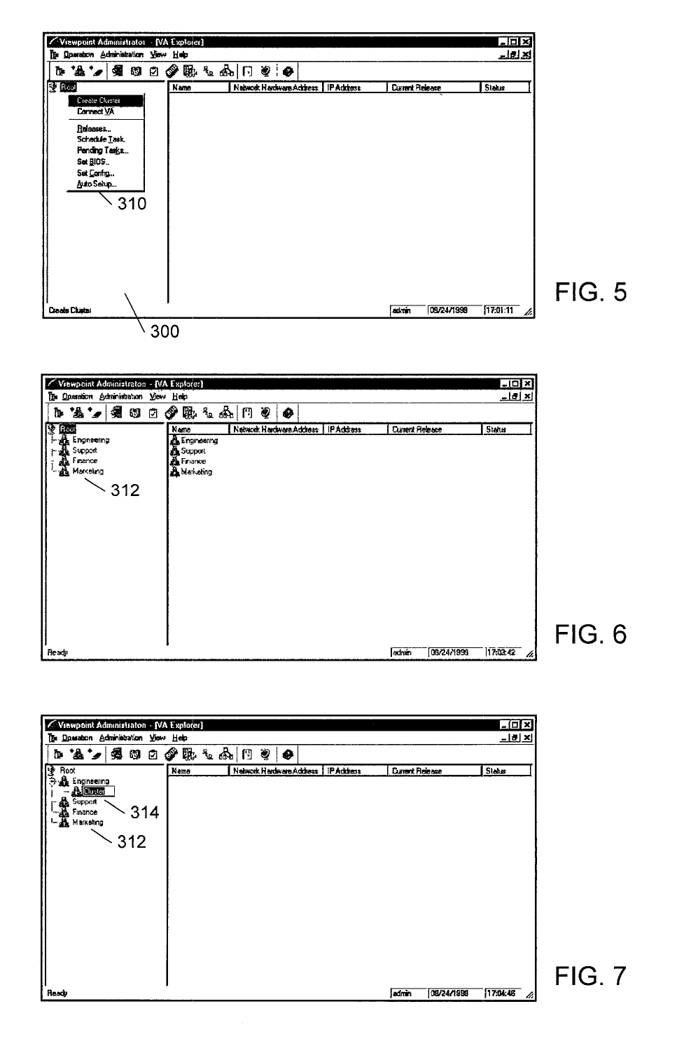

FIGS. 5-13: Graphical User Interface

FIGS. 5-13 illustrate one embodiment of a graphical user interface for one embodiment of the management program as described above.

Turning now to FIG. 5, one embodiment of a graphical user interface for managing clusters is shown. A blank network hierarchy tree called “Root” is shown in pane 300 Oust above pop-up menu 310 ). To add a new cluster or group of thin clients, the network administrator right-clicks on the “Root” icon and selects “Create Cluster” from pop-up menu 310.

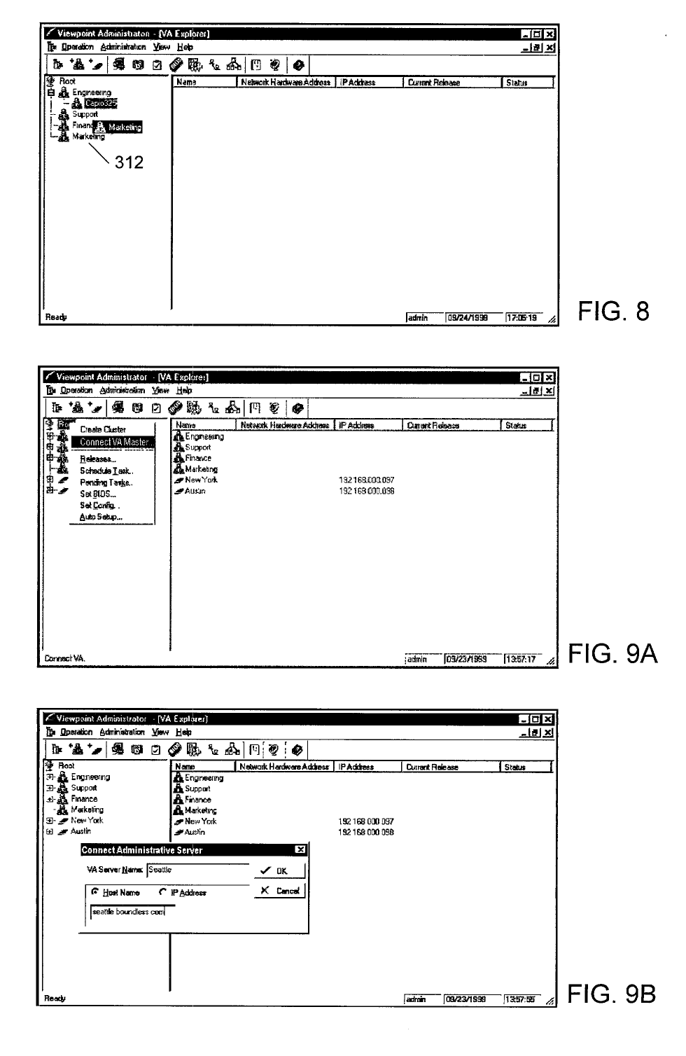

Turning now to FIG. 6, four new clusters of clients 312 are created named “Engineering”, “Support”, “Finance” and “Marketing”. FIG. 7 illustrates the creation of a sub-cluster 314 named “Capio 325” by right clicking on the Engineering cluster (and once again selecting “Create Cluster” from the pop-up menu shown in FIG. 5). In this embodiment, drag-and-drop support for assembling and modifying clusters is provided. The network administrator may simply select one or more clients or clusters of the network hierarchy, and then drag the clients or clusters to a new location to form a new cluster or hierarchy within the cluster. FIG. 8 illustrates the support of drag-and-drop functionality, by showing the reassignment of the “Marketing” cluster under the “Finance” cluster.

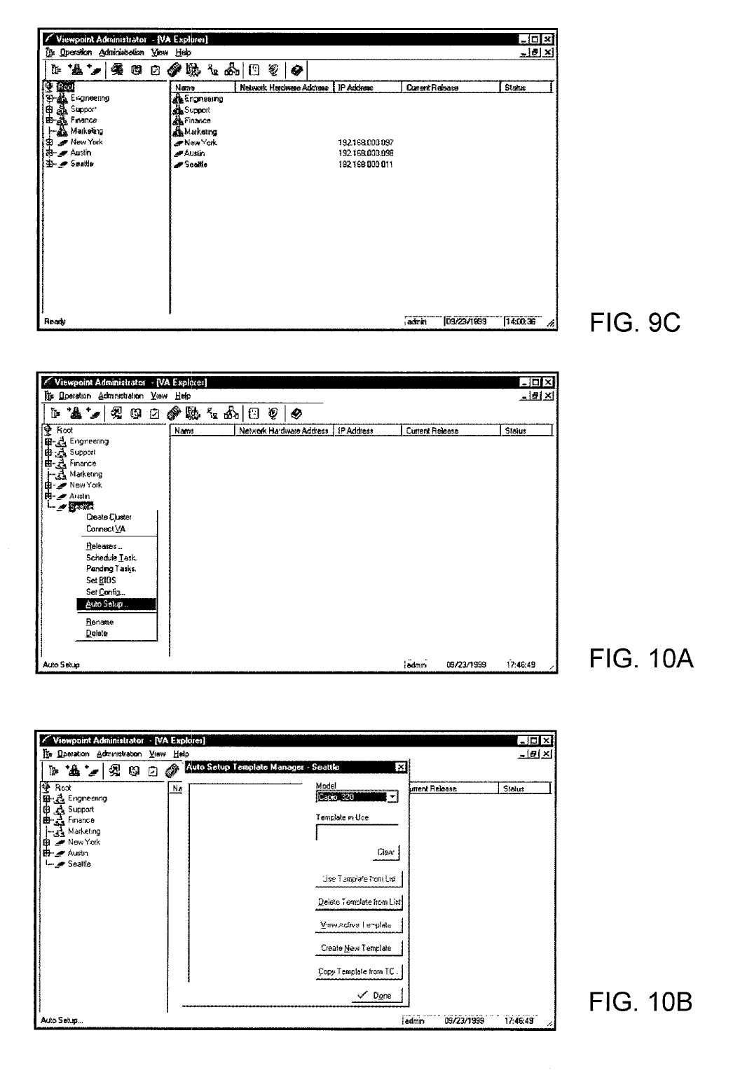

Assuming that a shipment of thin clients and a server were shipped to Seattle, FIGS. 9A-C, illustrate one embodiment of a method for adding an administrative server named Seattle to the hierarchy. In these figures, the administrative server is added to the top of the hierarchy (i.e., the “Root”) by right clicking the root icon, selecting “Connect Administrative Server . . . ”from the pop-up menu, and entering a name and address for the administrative server (see FIG. 9B). The resulting administrative server entry is named Seattle as illustrated in the hierarchy in FIG. 9C.

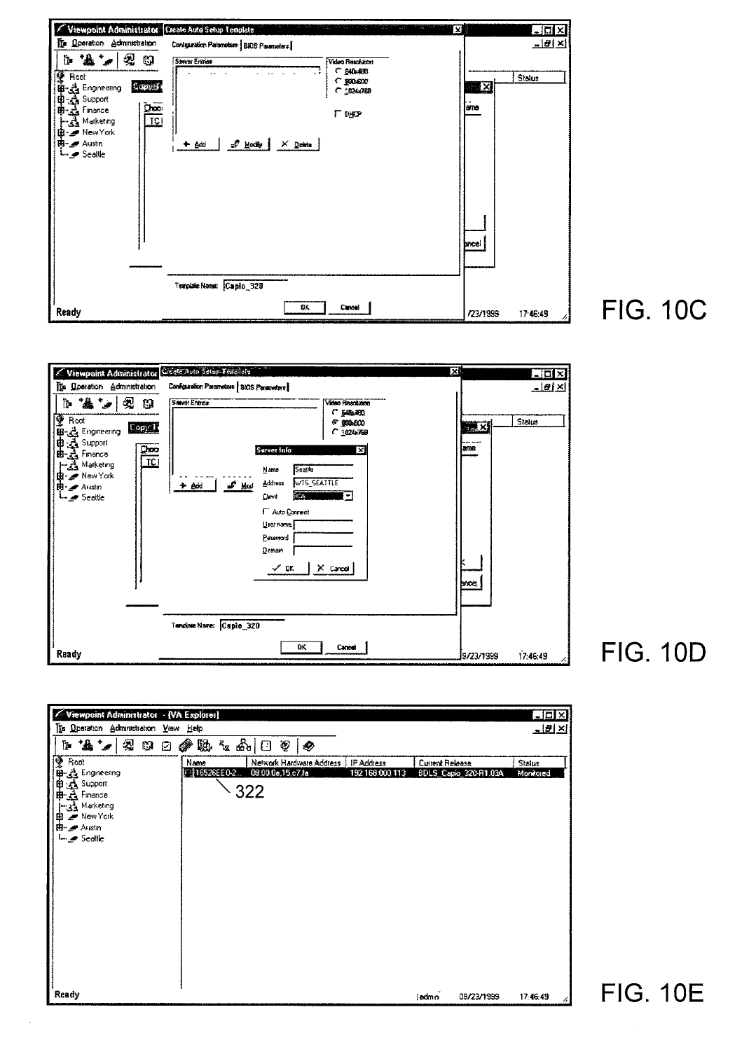

As described above, the thin client management program may be configured to automatically configure newly detected thin clients with a default configuration. Advantageously, once an on-site technician has configured and installed the administrative server, the other clients may be automatically configured. This is illustrated in FIGS. 10A-E. In FIG. 10A, the administrative server is selected for automatic configuration. In FIG. 10B, the thin client device type (i.e., in this case a thin client model “Capio 320” ) is selected. In FIGS. 10C-D a new default configuration (e.g., video resolution information) for the selected device type is specified. In FIG. 10E, the first thin client 322 controlled by the administrative server Seattle has been automatically configured using the Capio 320 configuration that was just generated.

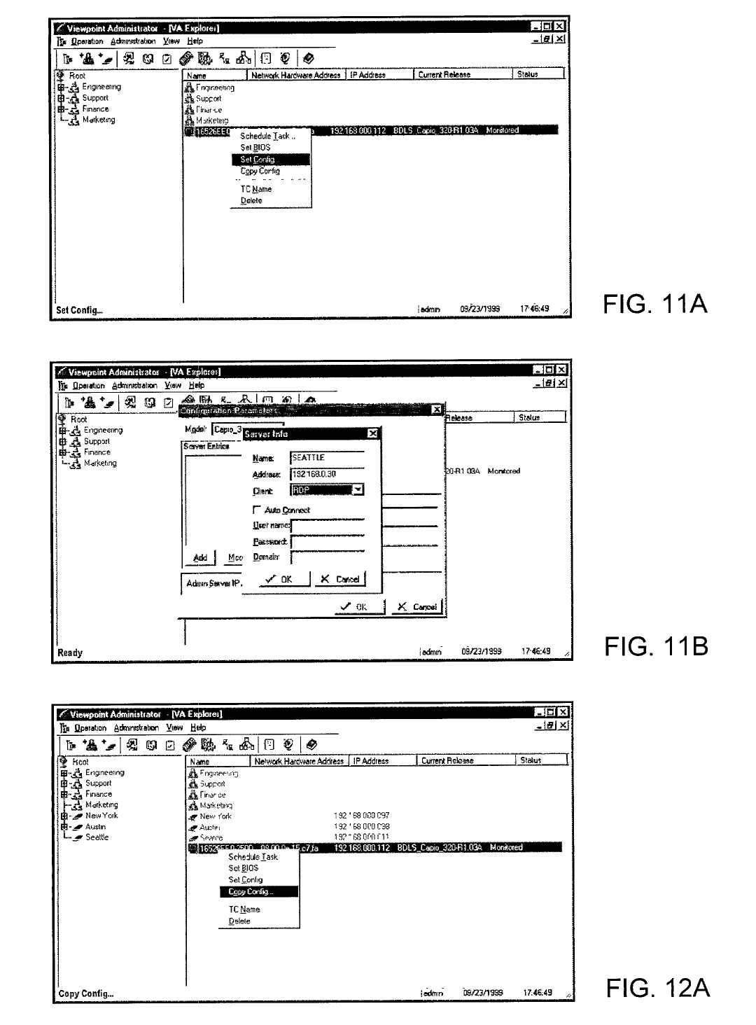

In addition to automatic configuration, manual and cluster configuration, may also be permitted. In FIG. 11A, the first thin client is selected for manual reconfiguration. In FIG. 11B the thin client is configured to receive updates from the administrative server Seattle.

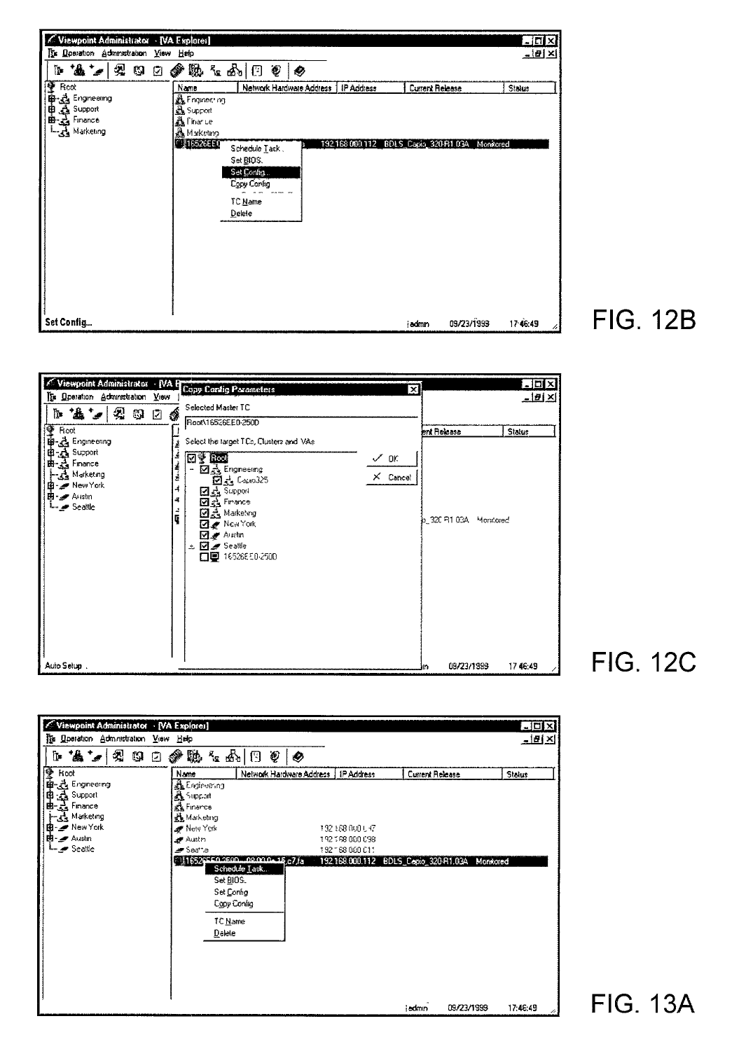

As previously discussed, the configuration from one thin client may be copied to other thin clients on the network. FIGS. 12A-C illustrate this process. In FIG. 12A, the first thin client is selected for configuration copying. In FIG. 12B, the target thin clients are selected (in this case, the entire hierarchy, as designated by “Root”). In FIG. 12C, the hierarchy is expanded to illustrate that all administrative servers' thin clients in the hierarchy have been selected. Optionally, individual administrative server and/or thin clients may be selected or deselected. In some embodiments, the management application may allow the network administrator to copy a configuration by simply selecting and dragging an icon representing a particular thin client onto a target thin client.

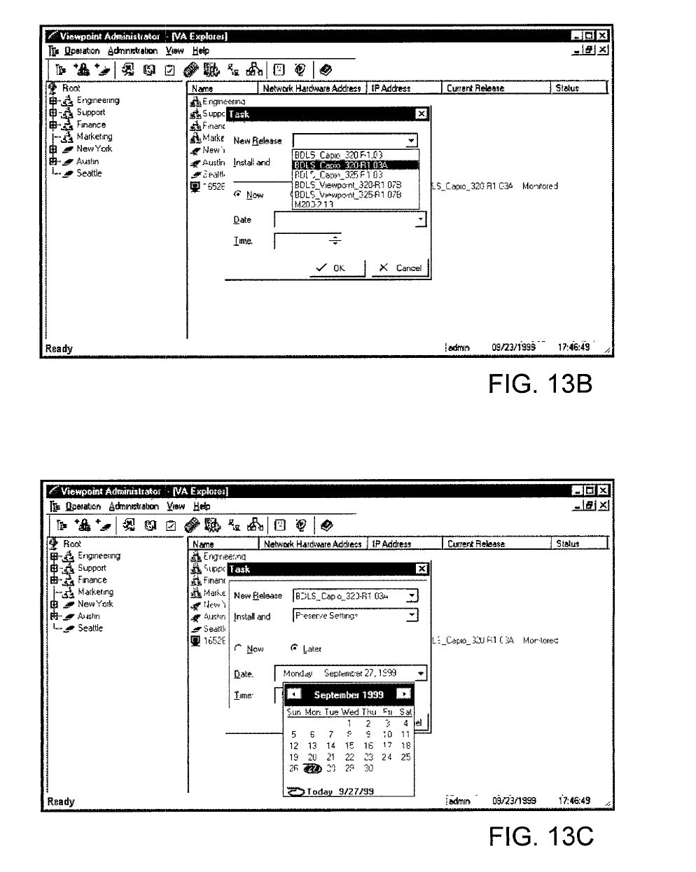

Turning now to FIGS. 13A-C, one embodiment of the management application configured to allow update tasks to be scheduled is shown. In FIG. 13A, a thin client is selected for updating. In FIG. 13B, a particular software update is selected (in this case, R1.03A for the Capio 320 model thin client). In FIG. 13C, a date and time is specified for the update.

As shown in the figures above, a particular thin client may be selected (e.g., through a double-click or right-click) to generate a pop-up menu of tasks that may be performed on the client (e.g., firmware update, and copy configuration). Similarly, in some embodiments multiple clients may be selected at the same time (e.g., by shift-clicking or by selecting a cluster name), and then a right-click may be performed to present a pop-up menu of tasks to be performed on the selected clients, regardless of whether the selected clients are in the same cluster or different clusters.

(SNMP) Simple Network Management Protocol

In one embodiment, the thin client management program described above may be implemented in multiple portions, with a main portion residing on the top level master administrative server, and with an agent portion that resides on lower level remote administrative servers and/or thin clients. The agent portion may be a software process that collects and distributes information on the operation of one or more thin clients on the network. The main portion of the management system application may be configured to gather information from one or more agent portions on demand to determine how well the network's thin clients are performing. The agent portions may be used to remotely manage clients (e.g., on a TCP/IP based network). Using a simple network management protocol (e.g., like the one described above), network management information can be transferred between two or more computers on the network (e.g., between two or more administrative servers). Network management information is any data that is used to monitor and/or control the state of a thin client. Using the agent portion, the clients connected to the server can be monitored remotely by applications which can receive SNMP messages.

In one embodiment, communications between the two application portions may be implemented using Simple Network Management Protocol (SNMP). This protocol includes a number of instructions configured to simplify the transfer of networking information. Listed in Table 1 are examples of several different instructions that may be utilized to implement the system and method described above.

TABLE 1

| SNMP Instruction | Function |
|---|---|
| get | retrieve client information |
| set | set client configuration |
| trap | alert for changes in client information |

In one embodiment, the management system may send messages to the agent portion in the form of “get”, “get-next” or “set” instructions as shown in Table 1. The agent portion may reply to the instructions with a response that indicates whether the operation was performed successfully (response) or if a spontaneous event (e.g., an error) occurred (trap). The agent portion can also send selected data to the management system along with the trap (e.g., details about the unexpected behavior and client status).

In one embodiment, the agent portion may be configured to perform tasks such as executing traps in response to detecting a change in the thin client's status and providing client information to the management system portion. This information maybe provided from a database of assembled client information, or the agent may be configured to directly query the designated client. Examples of the types of information that the agent may provide the management system include the client's name (e.g., in response to an IP address or medium access controller (“MAC”) address), the client's IP address (e.g., in response to the client's name or MAC address), MAC address (e.g., in response to the client's name or IP address), and information about the software on the client (e.g., the client's current operating system software release level). The management system portion may be configured to maintain this information in database (referred to herein as the MIB, or management information base).

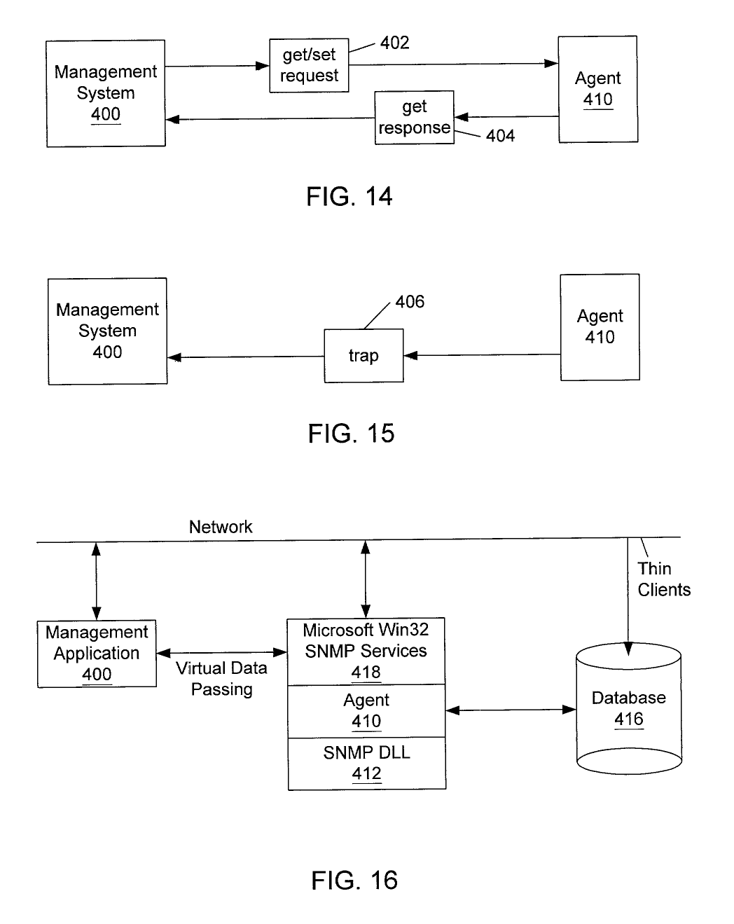

Turning now to FIG. 14, a data flow diagram illustrating the transfer of instructions between the management system portion and the agent is illustrated. As shown in the figure, the management system portion 400 may be configured to convey a get or set instruction 402 to the agent portion 410. In response, the agent is configured to convey a response 404 to management system 400.

Turning now to FIG. 15, a diagram illustrating the transfer of trap information from agent portion 410. As shown in the figure, the agent may utilize trap 406 to report an event to the management system portion 400.

Turning now to FIG. 16, one embodiment an implementation of the network management application is illustrated. In this embodiment, the management application portion 400 is configured to utilize virtual data passing available using Microsoft's SNMP services 418 to communication with agent portion 410. Similarly, agent portion 410 is configured to utilize the dynamically linked libraries (DLLs) available through Microsoft's SNMP to store and retrieve information from database 416.

As noted above, the agent portion 410 may be configured to send traps to the management system portion application. Each thin client has some attributes like a name, IP address, MAC address, software release (e.g., including version number), and status. Given a value for one attribute, agent portion 410 returns the values of remaining attribute to the management system portion 400.

In one embodiment, management application portion 400 may reside on the top-level master administrative server (e.g., server 202A in FIG. 4). The SNMP services 418 may reside on both the top-level master administrative server and the lower-level remote administrative servers (e.g., servers 202A-C in FIG. 4). The database 416 may exist on both the top-level master administrative server and the lower-level remote administrative servers (e.g., servers 202A-C in FIG. 4).

In one embodiment, Microsoft Win32 SNMP Service 418 is implemented as a Win32 system service. Under Windows NT there are actually two SNMP services. The first is the SNMP agent service (SNMP.EXE). The agent portion 410 processes SNMP Request messages that it receives from SNMP management systems and sends GetResponse messages in reply. The agent portion 410 may also be responsible for sending trap messages to the SNMP management systems. The SNMP support for agent portion 410 is available under both Windows NT and Windows 95. The SNMP agent support service is also referred to as the “Windows NT extendible SNMP agent”. An “extendible” agent allows MIB information to be dynamically added and supported as required. As indicated in the figure, agent portion 410 resides within the SNMP service 418. The second service is the SNMP trap service (SNMPTRAP.EXE), which listens for traps sent to the NT host and then passes the data along to the Microsoft SNMP management application. Note, the SNMP trap service is not available under Windows 95.

The agent portion 410 may be configured to retrieve the thin client information from the MIB database 416 and send it to the management portion.

In one embodiment, SNMP DLL is SnmpAgt2DB.dll, and contains API functions for fetching data from the MIB database 416. In some embodiments, all the database operations in the agent portion 410 are performed using API functions present in this DLL.

Once the SNMP service is started, all of the extension agents specified in the registry are loaded into memory and initialized. When the service is stopped, all extension agent DLLs are unloaded from memory and Windows NT will no longer respond to SNMP requests or send traps.

Agent portion 410 may be implemented as a Dynamic Link Library, and may be loaded into memory when the SNMP Service is started. The agent portion 410 may use the polling mechanism within SNMP set to a one-minute time delay for sending traps to the management system portion 400. When there is a change in the thin client status, agent portion 410 may send the trap to the management application 400 with the help of Win32 Trap service 418. Agent portion 410 may then utilize the SnmpAgt2DB.DLL 412 for fetching data from the thin client database 416. Get and Set requests may also be implemented in agent portion 400. To retrieve information about a particular thin client, the management portion 400 sends the get-request to the Windows SNMP Service 418 that in turn passes the request to the agent portion 410. The agent portion 410 retrieves the information from the thin client database 416 using API calls present in the SnmpAgt2DB.DLL 412. This retrieved information will be sent to the management system portion 400 through SNMP Service 418. The management application can reside on the same computer or on a different computer (i.e., in a remote configuration). Data may be passed between the management application 400 and agent portion 410 using agent services present in the Windows NT SNMP Service 418.

In another embodiment, a “Set” instruction is first sent to notify the agent portion 410 about which thin client's information is needed. A “Get Request” instruction is then sent to obtain the particular list of information that is desired. Advantageously, this technique may be faster and more efficient than sending “Get” and “Get-next” requests until the desired object is returned. This may save bandwidth, which as noted above, may be limited in many cases. To support this feature, in some embodiments agent portion 410 may be required to be part of any remote administrative server installation.

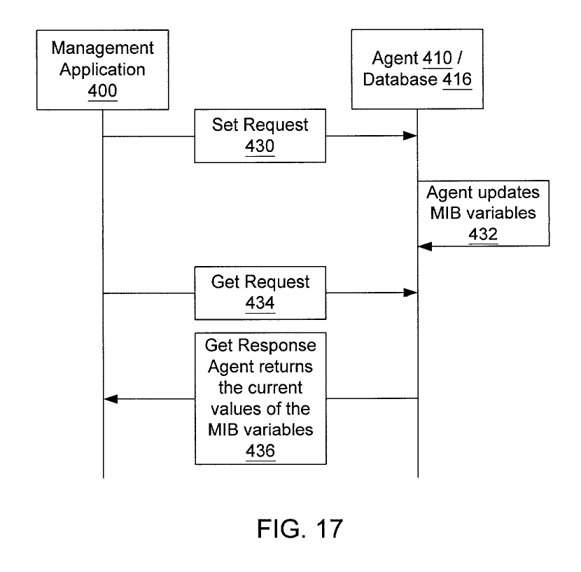

Turning now to FIG. 17, an event trace diagram for retrieving thin client information is shown. Agent portion 410 receives a set-request 430 from the management system portion 400, and in response agent portion 410 may update the values of the MIB variables by retrieving data from the database 418. In response to a get-request 434, the agent portion 432 returns the current values of the MIB variables 436.

In one embodiment, the MIB (Management Information Base) file contains the information needed by the managing system portion 300 to control a thin client and discover the thin client's detailed information. The MIB file may contain information such as the thin client's name, IP address, MAC address (i.e., its network adapter identifier), and the thin client's current status (for example, whether it is currently in use by a managing application). The agent portion 410 remotely manages the nodes or entities on a TCP/IP based network. Using SNMP, network management information can be transferred between two or more network nodes. Network management information consists of any data used to monitor or control the state of a network node. The management portion 400 (executing on the top-level master administrative server) can rely on the agent portion 410 to remotely monitor any thin clients that are connected to remote administrative servers executing the agent portion 410.

Note, while the embodiments shown above illustrate the use of Microsoft's SNMP, other protocols may also be used to implement the system and method disclosed herein. For example, CMIP (Common Management Information Protocol) instructions may be utilized to implement the communication process described above.

Although the system and method of the present invention have been described in connection with several embodiments, the invention is not intended to be limited to the specific forms set forth herein, but on the contrary, it is intended to cover such alternatives, modifications, and equivalents as may be reasonably included within the spirit and scope of the invention as defined by the appended claims.

What is claimed is:

1. A computer program embodied on a computer-readable medium, wherein the computer program comprises a plurality of instructions, wherein the plurality of instructions are configured to:
detect a plurality of computers that are connected by a network; and
construct a management hierarchy for the plurality of computers, wherein one of the computers is designated as a master administrative server, wherein one or more of the computers are designated as remote administrative servers, and wherein one or more of the computers are designated as thin clients, wherein the master administrative server is configured to manage configuration updates for the remote administrative servers which are configured to manage configuration updates for the thin clients.

2. The computer program as recited in claim 1, wherein the master administrative server is configured to directly manage a first subset of the thin clients, and wherein the master administrative server is configured to indirectly manage a second subset of the thin clients through the remote administrative servers.

3. The computer program as recited in claim 2, wherein each remote administrative server is configured to directly manage one or more thin clients from the second subset of thin clients.

4. The computer program as recited in claim 1, wherein the program is configured to configure the thin clients to access one or more application servers to execute applications.

5. The computer program as recited in claim 1, wherein the program is configured to configure each thin client to access one remote administrative server or the master administrative server for configuration updates.

6. The computer program as recited in claim 1, wherein the program is configured to configure each thin client to access one or more application servers to execute applications.

7. The computer program as recited in claim 6, wherein one or more of the application servers are also administrative servers.

8. The computer program as recited in claim 1, wherein the plurality of instructions are further configured to automatically update each thin client by conveying update information to the thin clients, wherein the master administrative server is configured to convey update information to at least one of the thin clients by forwarding the update information via one or more remote administrative servers.

9. The computer program as recited in claim 1, wherein the master administrative server is configured to convey update information to one or more of the thin clients by forwarding the update information via one or more remote administrative servers in response to the one or more thin clients joining the network.

10. The computer program as recited in claim 1, wherein each administrative server is configured to operate in parallel.

11. The computer program as recited in claim 1, wherein each administrative server is configured to distribute the update in parallel to the thin clients once the update is received.

12. The computer program as recited in claim 1, wherein the plurality of instructions are further configured to display at least part of a hierarchical network diagram of the management hierarchy, wherein the diagram comprises a plurality of icons each representing one administrative server or thin client in the network.

13. The computer program as recited in claim 1, wherein the plurality of instructions are further configured to display at least part of a hierarchical network diagram of the management hierarchy, wherein the diagram comprises a plurality of icons each representing one administrative server, thin client, or cluster of administrative servers and thin clients in the network.

14. The computer program as recited in claim 1, wherein the plurality of instructions are further configured to cause at least one administrative server to allow any other administrative server requesting control to take over management of configuration updates.

15. The computer program as recited in claim 1, wherein the plurality of instructions are further configured to cause at least one administrative server to prevent another administrative server from taking over management of configuration updates.

16. The computer program as recited in claim 1, wherein the plurality of instructions are further configured to prevent at least one administrative server from relinquishing control to another administrative server in response to a request to seize control unless the request to seize control originates from a specified network address.

17. The computer program as recited in claim 1, wherein the plurality of instructions are configured to cause the administrative servers to:
receive error messages from the thin clients;
propagate the error messages up the management hierarchy; and
generate an error summary.

18. The computer program as recited in claim 1, wherein the plurality of instructions are configured to cause the administrative servers to:
receive status messages from the thin clients;
propagate the status messages up the management hierarchy; and
generate a status summary.

19. The computer program as recited in claim 18, wherein status summary includes only serious error messages corresponding to each particular administrative server.

20. The computer program as recited in claim 1, wherein the plurality of instructions are further configured to provide a graphical user interface.

21. A method for managing a network of computers, the method comprising:
displaying at least part of a hierarchical network diagram of the network, wherein the diagram comprises a plurality of icons each representing one computer in the network;
prompting a user to configure a first computer in the network with a default configuration, wherein the first computer is a thin client;
allowing the user to select one or more additional computers in the network by selecting one or more icons corresponding to the one or more additional computers, wherein the one or more additional computers are thin clients;
comparing the one or more additional computers' hardware with the first computer's hardware; and
copying the default configuration to the each of the one or more additional computers that meet the first computer's level of hardware.

22. The method as recited in claim 21, further comprising allowing the user to select the one or more additional computers by shift-clicking icons representing the one or more additional computers.

23. The method as recited in claim 21, wherein two or more of the computers in the network are administrative servers configured to manage updates for at least one or more of the thin clients in the network, wherein the method further comprises allowing the user to select the one or more additional thin clients by clicking icons representing one or more administrative servers in the network diagram, wherein clicking a particular administrative server selects all thin clients managed by the particular administrative server.

24. The method as recited in claim 21, further comprising allowing the user to select the one or more additional thin clients by dragging an icon representing the first thin client over one or more icons representing the one or more additional thin clients.

25. The method as recited in claim 21, further comprising allowing the user to configure one or more computers as administrative servers, wherein the administrative servers are configured to manage updates for one or more of the thin clients in the network.

26. The method as recited in claim 25, wherein at least administrative server is a master administrative server configured to manage updates for one or more other administrative servers.

27. The method as recited in claim 21, further comprising allowing the user to create one or more clusters by selecting icons representing thin clients that are cluster members.

28. The method as recited in claim 21, further comprising allowing the user to create one or more clusters by selecting icons representing administrative servers that manage thin clients that are cluster members.

29. The method as recited in claim 25, further comprising:
performing a network-wide update for all thin clients by:
downloading update information to each administrative server, and
configuring each administrative server to automatically download the update information to all thin clients managed by the administrative server.

30. The method as recited in claim 29, wherein each particular administrative server is configured to download the update information to the thin clients controlled by the particular administrative server in parallel with other administrative servers.

31. The method as recited in claim 25, further comprising:
configuring a particular administrative server to prevent the particular administrative server from relinquishing control to another administrative server.

32. The method as recited in claim 25, further comprising:
configuring a particular administrative server to prevent the particular administrative server from relinquishing control to another administrative server that does not have a predetermined network address.

33. The method as recited in claim 25, further comprising:
configuring a particular administrative server to relinquish control to any other administrative server that requests control.

34. The method as recited in claim 25, further comprising:
generating an error summary for each particular administrative server, wherein each error summary includes at least the most severe fault message from each thin client and administrative server managed by the particular administrative server.

35. The method as recited in claim 21, wherein the level of hardware includes one or more of the following attributes: amount of memory, graphics resolution, and color depth.

36. A method for managing a network of thin clients and servers, wherein the method comprises:
designating a first server as a top-level master administrative server in a management hierarchy;
designating a second server as a remote administrative server managed by the top-level master administrative server;
specifying a first subset of thin clients that will receive configuration update information from the top-level master administrative server;
specifying a second subset of thin clients that will receive configuration update information from the remote administrative server; and
performing a thin client configuration update by:
conveying update information from the top-level master administrative server to the remote administrative server, and
conveying the update information from the top level master administrative server to the first subset of thin clients at least partially in parallel with
conveying the update information from the remote administrative server to the second subset of thin clients.

37. The method as recited in claim 36, wherein the update information comprises at least one or more of the following: display resolution information, color depth information, and application server address information.

38. The method as recited in claim 36, further comprising automatically detecting new thin clients that are connected to the network and automatically providing the new thin clients with configuration information specifying the remote administrative servers' network address.

39. A computer network configured to allow hierarchical management, wherein the network comprises:
a top-level master administrative server;
one or more remote administrative servers, wherein each remote administrative server is connected to the top-level master administrative server via a network;
one or more thin clients, wherein each thin client is connected to one of the remote administrative servers or the master administrative server via the network, wherein the top-level master administrative server is configured to convey update information for one or more of the thin clients to the remote administrative servers, wherein the remote administrative servers are configured to forward the update information to the one or more thin clients.

40. The computer network as recited in claim 39, wherein the remote administrative servers are configured to forward the update information to the one or more thin clients substantially in parallel.

41. The computer network as recited in claim 39, wherein a subset of the remote administrative servers are configured to be master/remote administrative servers and to receive updates from the top-level master administrative server and forward the updates to one or more other remote administrative servers.

42. The computer network as recited in claim 39, wherein the remote administrative servers are configured in a control hierarchy, wherein the top-level master administrative server is the top or root of the control hierarchy.

43. The computer network as recited in claim 39, wherein one or more of the remote administrative servers are connect to the wherein the remote administrative servers are configured to forward the update information to the one or more thin clients substantially in parallel.

44. The computer network as recited in claim 39, wherein each remote administrative server is connected to the top-level master administrative server via a first type of network connection, wherein each thin client is connected to one of the remote administrative servers or the master administrative server via a second type of network connection.

45. The computer network as recited in claim 39, further comprising one or more application servers connected to the thin clients, wherein the application servers are configured to store and execute applications for the thin clients.

46. The computer network as recited in claim 45, wherein one or more of the top-level master administrative server and the remote administrative servers are the one or more application servers.

47. The computer network as recited in claim 39, wherein the first type of network connection and the second type of network connections each comprise one or more of the following: Ethernet, ISDN (integrated services digital network), DSL (digital subscriber line), or telephone dial-up.

48. The computer network as recited in claim 39, wherein the first type of network connection is an Ethernet local area network (LAN) connection.

49. The computer network as recited in claim 39, wherein the first type of network connection is a dial-up connection.

50. The computer network as recited in claim 39, wherein the second type of network connection is an Ethernet local area network (LAN) connection.

51. The computer network as recited in claim 39, wherein the second type of network connection is a dial-up connection.
